(19) United States
(12) Patent Application Publication
(10) Pub. No.: US 2025/0056171 A1
(43) Pub. Date: Feb. 13, 2025

(54) BONE CONDUCTION HEARING-AID UNIT

(71) Applicants: The University of Electro-Communications, Tokyo (JP); Ehime University, Ehime Pref. (JP); KEIO UNIVERSITY, Tokyo (JP); NIHON KOHDEN CORPORATION, Tokyo (JP)

(72) Inventors: Takuji KOIKE, Tokyo (JP); Naohito HATO, Toon-shi (JP); Sho KANZAKI, Tokyo (JP); Katsuyoshi SUZUKI, Tokorozawa-shi (JP)

(73) Assignees: The University of Electro-Communications, Tokyo (JP); Ehime University, Ehime Pref. (JP); KEIO UNIVERSITY, Tokyo (JP); NIHON KOHDEN CORPORATION, Tokyo (JP)

(21) Appl. No.: 18/790,832

(22) Filed: Jul. 31, 2024

(30) Foreign Application Priority Data
Aug. 8, 2023 (JP) 2023-129559

(51) Int. Cl. H04R 25/00

(52) U.S. Cl. CPC H04R 25/606; H04R 2225/67

(57) ABSTRACT

A bone conduction hearing-aid unit embedded under a scalp. The bone conduction hearing-aid unit includes a vibration generator configured to generate vibration, and an anchor. A magnetic field frequency is applied to the vibration generator from the outside of the scalp to generate vibration. The vibration is transmitted to a skull via the anchor.

### CROSS-REFERENCE TO RELATED APPLICATIONS

This application is based on and claims priority under 35 USC 119 from Japanese Patent Application No. 2023-129559 filed on Aug. 8, 2023, the entire content of which is incorporated herein by reference.

### TECHNICAL FIELD

The presently disclosed subject matter relates to a bone conduction hearing-aid unit that provides hearing aid by transmitting vibration to an inner ear through bone conduction of a skull.

### BACKGROUND ART

For a patient with conductive hearing loss due to impaired middle ear function, a hearing aid that transmits vibration to an inner ear through bone conduction has been developed. The hearing aid of JP2004-289219A transmits vibration to an inner ear through bone conduction, and includes a hearing-aid driving unit embedded in a skull. The hearing-aid driving unit of JP2004-289219A is directly attached to the skull, covered with a scalp, and connected by a cord to an external device provided with a microphone. Therefore, treatment is necessary to prevent infection between the scalp and the cord. JP2004-289219A also describes the hearing aid in which the hearing-aid driving unit and the external device are connected via wireless communication. However, a cable is led out from the skin and connected to a battery outside the skin, and it is necessary to take measures for infectious diseases between the skin and the cable. Although an intracorporeal battery that generates power by blood flow is also described, such intracorporeal power generation needs to prevent the occurrence of thrombus. When a battery is provided in the hearing-aid driving unit, it is necessary to periodically make an incision in the scalp to replace the battery. It is conceivable to charge a secondary battery by wireless power supply, but this would result in a large device. Further, when the secondary battery deteriorates, it is necessary to replace the secondary battery.

In the bone conduction hearing aid of JP5219037B, a transducer around which a transducer driving coil is wound is provided in an intracorporeal unit embedded in a skull. An audible sound modulation transmission signal is transmitted from an extracorporeal transmission coil provided in an extracorporeal unit to an intracorporeal reception coil provided in the intracorporeal unit by a transmission magnetic flux, and an excitation current generated in the intracorporeal reception coil is transmitted to the transducer driving coil to drive the transducer to expand and contract. In this way, the audible sound signal can be transmitted with high accuracy without providing a power supply or a demodulation circuit in the intracorporeal unit. In addition, no wiring is led out from the scalp, and the risk of infectious diseases is low.

However, in the bone conduction hearing aid of JP5219037B, the intracorporeal unit includes the intracorporeal reception coil and the transducer driving coil for the transducer, which results in a large intracorporeal unit.

### SUMMARY OF INVENTION

Aspect of non-limiting embodiments of the present disclosure relates to provide a small bone conduction hearing-aid unit having a low risk of infectious diseases.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an aspect of the present disclosure, there is provided a bone conduction hearing-aid unit embedded under a scalp, the bone conduction hearing-aid unit including:
a vibration generator configured to generate vibration; and
an anchor,
in which a magnetic field frequency is applied to the vibration generator from the outside of the scalp to generate vibration, and
the vibration is transmitted to a skull via the anchor.

### BRIEF DESCRIPTION OF DRAWINGS

Exemplary embodiment(s) of the present invention will be described in detail based on the following figures, wherein:

FIG. 1 is a diagram illustrating a state in which a bone conduction hearing-aid unit of a first embodiment is attached to a skull;

FIG. 2 is a side view of the bone conduction hearing-aid unit of the first embodiment attached to a head as viewed from a first direction;

FIG. 3 is a side view of the bone conduction hearing-aid unit of the first embodiment attached to the head as viewed from a second direction;

FIG. 4 is a top view of an extracorporeal unit of the first embodiment;

FIG. 5 is a top view of the bone conduction hearing-aid unit of the first embodiment;

FIG. 6 is a top view of a fixing plate of the first embodiment;

FIG. 7 is a cross-sectional view of the fixing plate of the first embodiment;

FIG. 8 is a bottom view of the fixing plate of the first embodiment;

FIG. 9 is a side view of an anchor of the first embodiment;

FIG. 10 is a top view of the bone conduction hearing-aid unit of the first embodiment with a top case detached;

FIG. 11 is a view of the bone conduction hearing-aid unit of the first embodiment with the top case detached, as viewed from a direction opposite to the first direction;

FIG. 12 illustrates the movement of a vibration generator of the first embodiment as viewed from the direction opposite to the first direction;

FIG. 13 is a cross-sectional view of the bone conduction hearing-aid unit of the first embodiment;

FIG. 14 is a cross-sectional view schematically illustrating a state before a vibration generating device is attached to the skull in the first embodiment;

FIG. 15 is a top view of a fixing plate of a second embodiment;

FIG. 16 is a top view of a fixing plate of a third embodiment;

FIG. 17 is a top view of a fixing plate of a fourth embodiment;

FIG. 18 is a top view of a fixing plate of a fifth embodiment;

FIG. 19 is a cross-sectional view of the fixing plate of the fifth embodiment;

FIG. 20 is a top view of another extracorporeal unit; and

FIG. 21 is a cross-sectional view of another extracorporeal unit attached to a head as viewed from the second direction.

### DESCRIPTION OF EMBODIMENTS

### First Embodiment

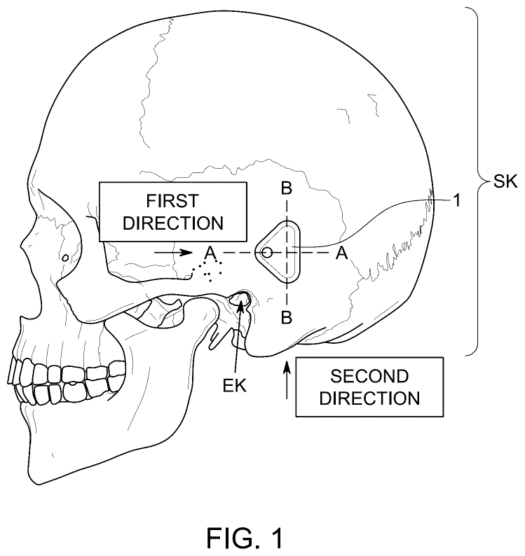

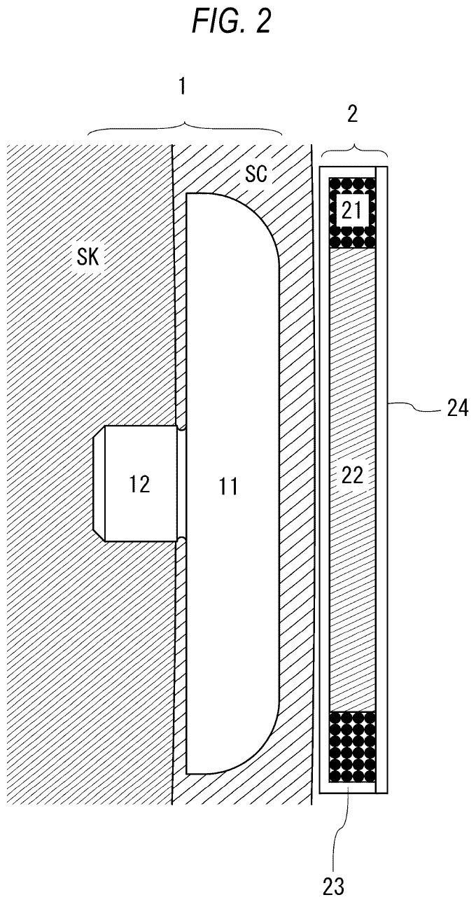

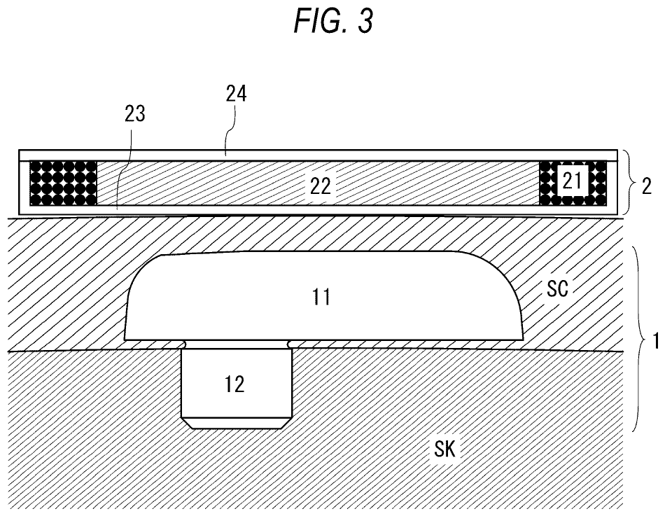

For a patient with conductive hearing loss due to impaired middle ear function, a bone conduction hearing-aid system of a first embodiment can transmit vibration to an inner ear through bone conduction, enabling the patient to recognize sounds. The bone conduction hearing-aid system of the first embodiment can include, in addition to a bone conduction hearing-aid unit 1 (illustrated in FIGS. 1 to 3 and the like) which is an intracorporeal unit, an extracorporeal unit 2 (illustrated in FIGS. 2 and 3 and the like), a sound collection unit 3 (not illustrated), and a wiring 4 (not illustrated) connecting the extracorporeal unit 2 and the sound collection unit 3. The same applies to other embodiments to be described later in this regard.

As illustrated in FIG. 1, the bone conduction hearing-aid unit 1, which is the intracorporeal unit of the first embodiment, is attached to a temporal part of a skull SK. In the present application, the temporal part to which the bone conduction hearing-aid unit 1 is attached is referred to as the top. A direction from a cheekbone to the back of the skull SK is referred to as a first direction. A direction opposite to the first direction is referred to as an opposite first direction. A direction from a neck to the top of the skull SK is referred to as a second direction. The same applies to other embodiments to be described later.

As illustrated in FIG. 1, the bone conduction hearing-aid unit 1 of the first embodiment is attached at a position deviated in the first direction and the second direction from an external auditory canal EK. The bone conduction hearing-aid unit 1 has a substantially isosceles triangle shape when viewed from above, and is disposed in the skull SK such that a direction from a vertex of the substantially isosceles triangle shape to a center of a bottom side is substantially the same as the first direction. The same applies to second to fourth embodiments to be described later in this regard.

FIG. 2 is a side view of the bone conduction hearing-aid unit 1 and the extracorporeal unit 2 disposed in a head of the patient as viewed from the first direction, and FIG. 3 is a side view of the bone conduction hearing-aid unit 1 and the extracorporeal unit 2 disposed in the head of the patient as viewed from the second direction. FIGS. 2 and 3 illustrate a state in which the bone conduction hearing-aid system including the bone conduction hearing-aid unit 1 and the extracorporeal unit 2 is in use. Regarding the skull SK, a scalp SC, and the extracorporeal unit 2, FIG. 2 illustrates a cross section taken along line B-B illustrated in FIG. 1, and FIG. 3 illustrates a cross section taken along line A-A illustrated in FIG. 1. During the use illustrated in FIGS. 2 and 3, the bone conduction hearing-aid unit 1 attached to the skull SK is covered with the scalp SC, and the extracorporeal unit 2 is disposed outside the scalp SC.

The bone conduction hearing-aid unit 1 has a structure in which a vibration generating device 11 having a vibration generator therein is fixed to an anchor 12. The anchor 12 has a male screw part, which is screwed into the skull SK and fixed, as illustrated in FIGS. 2 and 3. On the other hand, the vibration generating device 11 is not embedded in the skull SK and is covered with the scalp SC. The bone conduction hearing-aid unit 1 is completely embedded inside the scalp SC, and no wiring or the like is led out from the scalp SC. Therefore, there is no possibility of infectious diseases from between the scalp SC and the wiring, and the risk of infectious diseases is low.

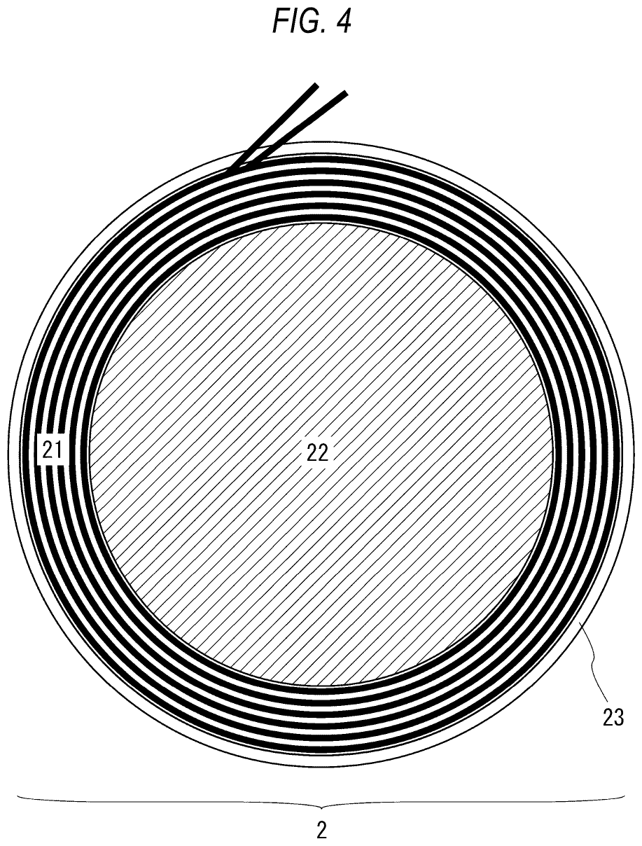

On the other hand, as illustrated in FIGS. 2 and 3, the extracorporeal unit 2 is disposed outside the scalp SC and used. In the extracorporeal unit 2, a coil 21 is wound around a magnetic body 22, is put in a case 23, and is closed with a lid 24. FIG. 4 illustrates a top view of the extracorporeal unit 2 with the lid 24 detached. In the extracorporeal unit 2, an electromagnet in which the coil 21 is wound around the thin columnar magnetic body 22 is accommodated in the case 23. The electromagnet has a disk shape whose diameter is larger than a length in an axial direction. Both ends of the coil 21 are led out to the outside of the case 23 and connected to the wiring 4 (not illustrated).

In the bone conduction hearing-aid system using the bone conduction hearing-aid unit 1, a sound signal collected and amplified by the sound collection unit 3 (not illustrated) is applied to the coil 21 of the extracorporeal unit 2 via the wiring 4 to generate a magnetic field frequency. As illustrated in FIGS. 2 and 3, the magnetic field frequency is applied to the vibration generating device 11 covered with the scalp SC, via the scalp SC. The sound collection unit 3 is of an ear hook type and is hung on an ear lobe and used. In the vibration generating device 11, vibration is generated by the magnetic field frequency and is transmitted to the skull SK via the anchor 12. The vibration is transmitted to the inner ear through bone conduction and is recognized by the patient as sounds. Since the energy of the vibration generated by the vibration generating device 11 is applied from outside the scalp SC by the magnetic field frequency, no wiring is led out from the scalp SC as illustrated in FIGS. 2 and 3, and the scalp SC is closed to the outside. Therefore, the risk of infectious diseases of the patient is low.

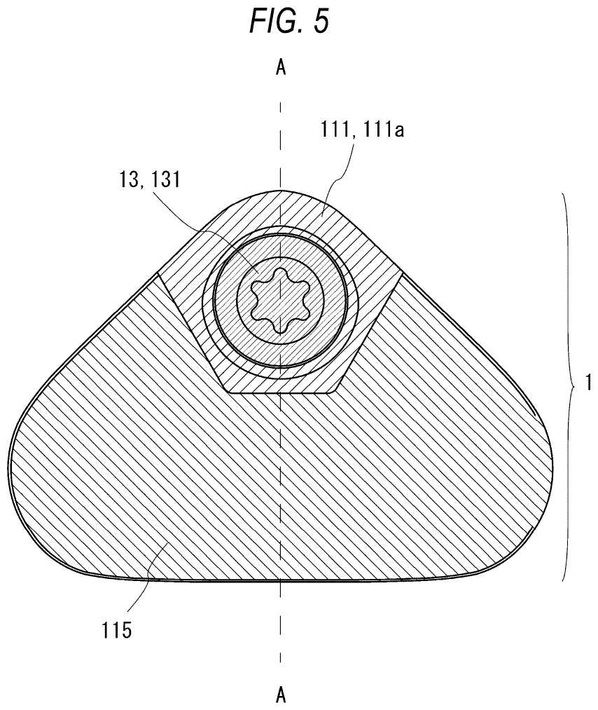

Next, the structure of the bone conduction hearing-aid unit 1 in the first embodiment will be described. FIG. 5 is a top view of the bone conduction hearing-aid unit 1 illustrated in FIGS. 1 to 3. FIG. 5 is an enlarged view of the bone conduction hearing-aid unit 1 illustrated in FIG. 1 rotated clockwise by 90°. In FIG. 5, a male screw 13 is inserted into a vibrator head 111a of a vibrator 111, and a screw head 131 can be seen. Portions other than the vibrator head 111a are covered with a top case 115.

In FIG. 5, the anchor 12 is detachably fixed to a back side of the position of the screw head 131. The vibration generating device 11 has a substantially triangle shape and is detachably fixed to the anchor 12 in the vicinity of one of three vertices. The vibration generating device 11 has a substantially isosceles triangle shape and is detachably fixed to the anchor 12 in the vicinity of a vertex far from the bottom side.

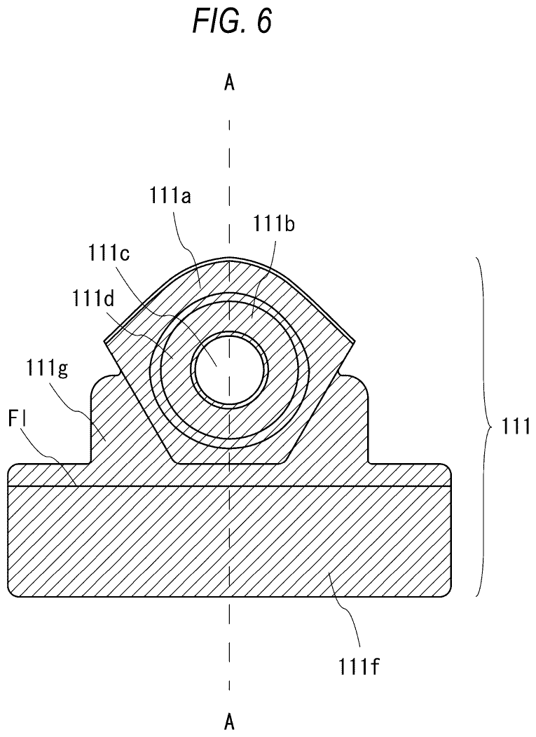

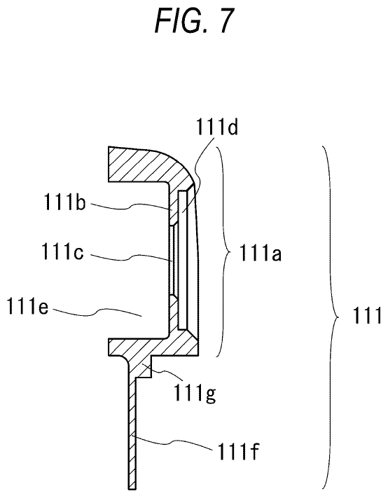

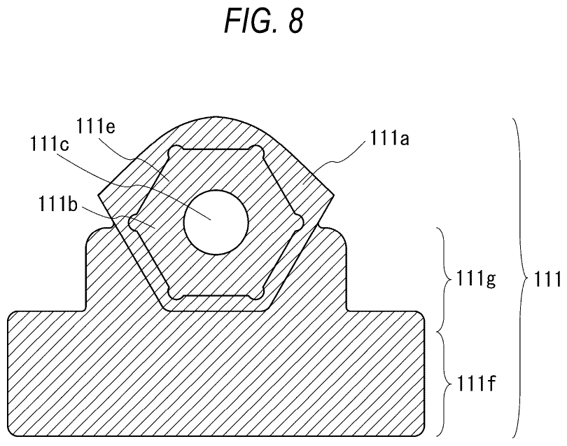

An overall view of the vibrator 111 illustrating the vibrator head 111a in FIG. 5 is illustrated in FIGS. 6 to 8. In a case where the top case 115, the male screw 13, and the like are detached from the bone conduction hearing-aid unit 1 of FIG. 5, the vibrator 111 illustrated in FIGS. 6 to 8 is obtained. The vibrator 111 is integrally formed with titanium. FIG. 6 is a top view of the vibrator 111, and FIG. 7 is a cross-sectional view taken along line A-A of the vibrator 111 of FIG. 6. FIG. 8 is a bottom view corresponding to a back side of the vibrator 111 of FIG. 6. In the vibrator 111, the vibrator head 111a and a fixing plate 111f are connected by a vibration conducting portion 111g. An upper surface of the fixing plate 111f has a substantially rectangular shape, and the vibrator head 111a is positioned on a lateral side of a fixing plate long side F1, which is a long side of the upper surface of the fixing plate 111f. As indicated by the line A-A in FIG. 6, the vibrator head 111a is positioned in a direction perpendicular to the fixing plate long side F1 from a center of the long side, and the vibration conducting portion 111g is provided between the vibrator head 111a and the fixing plate long side F1.

As illustrated in FIGS. 6 to 8, the vibrator head 111a can include an annular locking plate 11b on the inside, and a circular locking hole 111c is provided on the inside of the locking plate 11b. As illustrated in FIG. 7, the locking plate 11b is provided between an upper surface recess 111d and a lower surface recess 111e of the vibrator head 11a. The upper surface recess 111d is a circular recess as illustrated in FIGS. 6 and 7, and the lower surface recess 111e is a polygonal recess having a substantially hexagonal shape as illustrated in FIGS. 7 and 8.

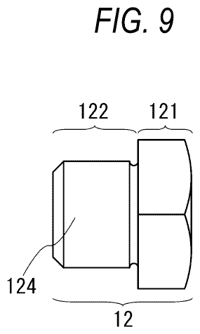

FIG. 9 is a side view of the anchor 12. The anchor 12 has a hexagonal bolt shape in which an anchor leg 122 protrudes from a hexagonal columnar anchor head 121, and is made of titanium. An outer peripheral surface of the anchor head 121 is hexagonal, and an outer surface of the anchor leg 122 forms a male screw portion 124. The anchor head 121 of the anchor 12 attached to the skull SK is fitted and fixed to the lower surface recess 11e of the vibrator head 111a of the vibrator 111 illustrated in FIGS. 7 and 8.

As illustrated in FIGS. 6 to 8, the fixing plate 111f is rectangular and thin. The vibration conducting portion 111g connects the vibrator head 111a and the fixing plate 111f. The vibration conducting portion 111g is thinner than the vibrator head 111a and is thicker than the fixing plate 111f. As illustrated in FIGS. 6 and 7, a step is formed between an upper surface of the vibration conducting portion 111g and the upper surface of the fixing plate 111f, and the upper surface of the vibration conducting portion 111g is positioned above the upper surface of the fixing plate 111f. On the other hand, as illustrated in FIGS. 7 and 8, no step is formed between lower surfaces of the vibration conducting portion 111g and the fixing plate 111f. The vibrator head 111a protrudes upward and downward from the vibration conducting portion 111g.

As illustrated in FIGS. 6 and 8, in the vibrator 111, the vibration conducting portion 111g has a rectangular shape with the same length as the fixing plate 111f, and has a shape in which a center closer to the vibrator head 111a protrudes in a small rectangular shape. The vibration conducting portion 111g has a convex shape in which a center connected to the vibrator head 111a protrudes laterally.

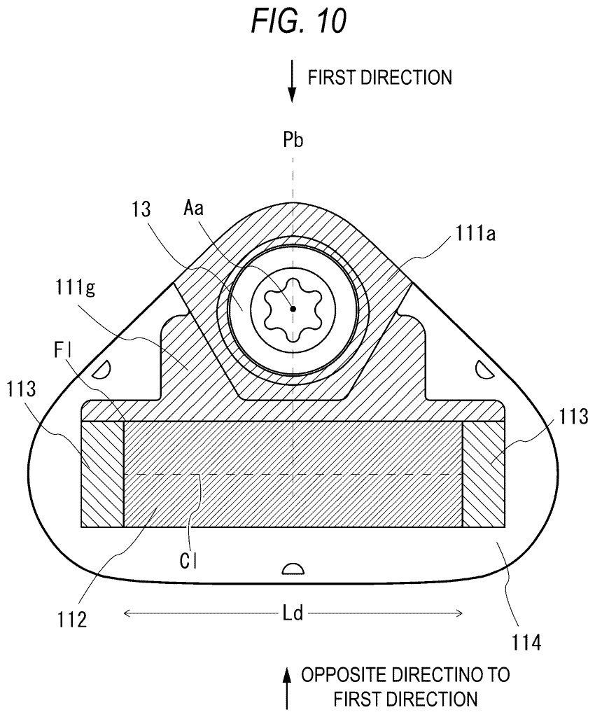

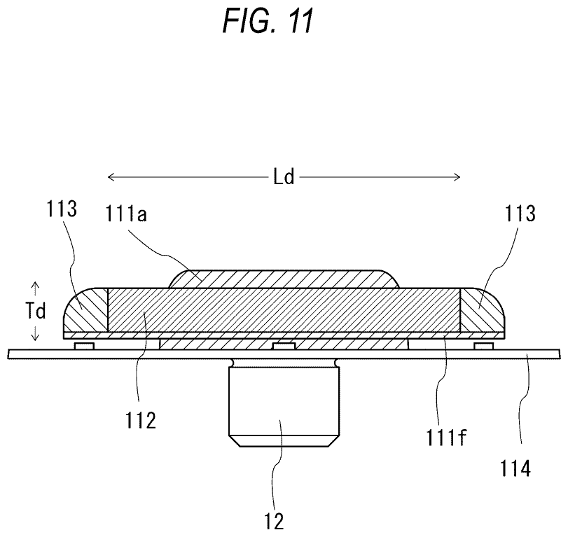

A giant magnetostrictive element 112 and the like are fixed to the vibrator 111. FIG. 10 illustrates a top view in which the top case 115 is detached from the bone conduction hearing-aid unit 1 of FIG. 5. FIG. 11 is a view of the bone conduction hearing-aid unit 1 illustrated in FIG. 10 with the top case 115 detached, as viewed from the opposite first direction. The giant magnetostrictive element 112 having a rectangular parallelepiped shape is fixed to the upper surface of the fixing plate 111f of the vibrator 111 having a rectangular shape. The giant magnetostrictive element 112 has a rectangular parallelepiped shape that is longest in a longitudinal direction Ld and shortest in a thickness direction Td, which is a vertical direction. The longitudinal direction Ld is a direction along the fixing plate long side F1 of the fixing plate 111f.

Permanent magnets 113 are provided at both ends of the giant magnetostrictive element 112 in the longitudinal direction Ld, and the giant magnetostrictive element 112 is sandwiched between the two permanent magnets 113. The permanent magnets 113 are fixed to the giant magnetostrictive element 112 and the fixing plate 111f. A length obtained by combing a length of the giant magnetostrictive element 112 and lengths of the two permanent magnets 113 in the longitudinal direction Ld is the same as the length of the fixing plate 111f. The upper surface of the fixing plate 111f and adhesion surfaces of the giant magnetostrictive element 112 and the two permanent magnets 113 to the fixing plate 111f have the same shape and size.

A bottom case 114 is provided on the back side of the vibrator 111. The bottom case 114 and the vibrator head 111a together with the top case 115 form an outer surface of the vibration generating device 11. In a case where the vibration generating device 11 is disposed, the longitudinal direction Ld of the giant magnetostrictive element 112 is substantially parallel to a surface of the skull SK. The longitudinal direction Ld of the giant magnetostrictive element 112 is perpendicular to the direction in which the anchor 12 is screwed into the skull SK.

As illustrated in FIG. 10, the fixing plate 111f is connected to the vibrator head 111a via the vibration conducting portion 111g. The bottom case 114 is fixed to the vibrator head 111a, but is not in contact with the fixing plate 111f or the vibration conducting portion 111g as illustrated in FIG. 11. The fixing plate 111f and the vibration conducting portion 111g are floated from the bottom case 114. The top case 115 illustrated in FIG. 5 is also fixed to the vibrator head 111a and the bottom case 114, but is not in contact with the vibration conducting portion 111g, the giant magnetostrictive element 112, the permanent magnets 113, or the like. Even in a case where the fixing plate 111f vibrates, the fixing plate 111f is not in contact with the bottom case 114 or the top case 115, and the vibration of the fixing plate 111f is transmitted to the vibrator head 11a via the vibration conducting portion 111g.

The anchor 12 is fitted and fixed at the position of the vibrator head 111a. The locking hole 111c is a hole through which the male screw 13 locking the anchor 12 passes, and is the position of the anchor 12. In FIG. 10, the anchor 12 is fixed to a back side of the male screw 13, and a central axis of the male screw 13 coincides with a central axis of the anchor. As illustrated in FIG. 10, in the bone conduction hearing-aid unit 1 of the first embodiment, an anchor axis Aa, which is the central axis of the anchor, is positioned away from the giant magnetostrictive element 112 in a direction perpendicular to a center line C1 extending in the longitudinal direction Ld of the giant magnetostrictive element 112. In FIG. 10, the anchor axis Aa extends in a direction perpendicular to the plane of the drawing. Further, the anchor axis Aa is provided at a position intersecting with a perpendicular bisector Pb of the center line C1, in the longitudinal direction Ld, of the giant magnetostrictive element 112.

### <Generation of Vibration>

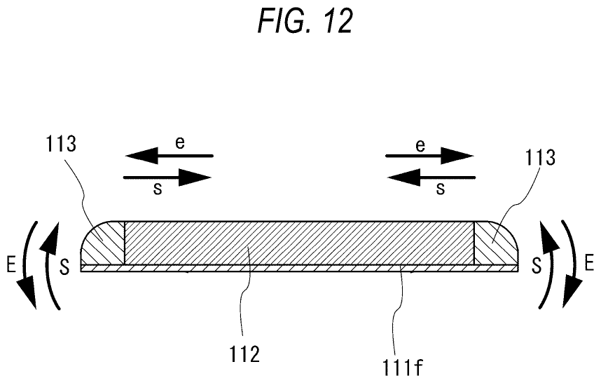

Next, how vibration is generated in the bone conduction hearing-aid unit 1 will be described. FIG. 12 illustrates the vibration generator in which vibration is generated as viewed from the opposite first direction. The vibration generator can include the giant magnetostrictive element 112, the permanent magnets 113, and the fixing plate 111f of the vibrator 111.

In a case where a magnetic field is applied to the giant magnetostrictive element 112, the length of the giant magnetostrictive element 112 changes. In a case where the magnetic field frequency is applied to the giant magnetostrictive element 112, the giant magnetostrictive element 112 expands and contracts. The permanent magnets 113 apply a bias magnetic field to the giant magnetostrictive element 112 to expand an expansion and contraction range. The permanent magnets 113 of the first embodiment are formed of neodymium magnets.

The giant magnetostrictive element 112 expands and contracts due to the magnetic field, but the fixing plate 111f to which the giant magnetostrictive element 112 is fixed does not expand and contract. Therefore, when the giant magnetostrictive element 112 contracts as indicated by an arrow s in FIG. 12, the giant magnetostrictive element 112 and the fixing plate 111f are bent in the direction of the arrow S. In a case where the giant magnetostrictive element 112 extends as indicated by an arrow e, the giant magnetostrictive element 112 and the fixing plate 111f are bent in the direction of the arrow E. Due to the magnetic field frequency, the vibration generator is bent alternately in the directions of the arrows S and E, and vibration is generated.

In this way, by causing the giant magnetostrictive element 112 to expand and contract by the magnetic field frequency, the vibration generator in which the giant magnetostrictive element 112 is fixed to the fixing plate 111f is alternately bent in one direction and the other direction, and bending vibration is generated in the vibration generator. Then, the vibration is transmitted from the fixing plate 111f illustrated in FIGS. 6 to 8 and 11 to the vibrator head 111a via the vibration conducting portion 111g, and is transmitted to the skull SK via the anchor 12.

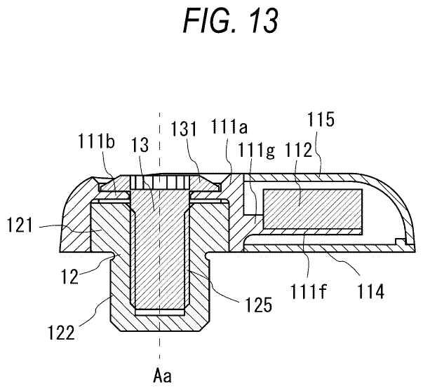

FIG. 13 illustrates a cross-sectional view of the bone conduction hearing-aid unit 1 in the first embodiment. FIG. 13 is a cross-sectional view taken along the line A-A of FIG. 5. In the vibrator 111, the bottom case 114 and the top case 115 are fixed at the vibrator head 111a. The bottom case 114 and the top case 115 are fixed to each other. The vibrator head 111a, the bottom case 114, and the top case 115 are made of titanium, and form an outer surface of the vibrator 111 to constitute a case.

FIG. 13 illustrates a state in which the anchor head 121 of the anchor 12 illustrated in FIG. 9 is fitted into the lower surface recess lie illustrated in FIGS. 7 and 8. The male screw 13, which is a fixing pin, is screwed into a female screw portion 125 of the anchor 12 from above the vibrator head 111a. In this way, the anchor 12 is fixed to the vibrator 111 with the locking plate 111b of the vibrator 111 sandwiched between the screw head 131 of the male screw 13 and the anchor head 121 of the anchor 12. The anchor leg 122 protrudes below the vibration generating device 11. The anchor 12 is also made of titanium.

FIG. 13 also illustrates a cross section of the vibration generator including the fixing plate 111f and the giant magnetostrictive element 112 fixed to the fixing plate 111f The vibration generating device 11 covers the vibration generator with the bottom case 114, the top case 115, and the vibrator head 111a to isolate the vibration generator from the outside. A surface of the giant magnetostrictive element 112 along the longitudinal direction Ld is fixed to the upper surface of the fixing plate 111f with an adhesive. The vibration conducting portion 111g is thicker than the fixing plate 111f and protrudes upward, and the giant magnetostrictive element 112 is in contact with a side surface of the protruding portion of the vibration conducting portion 111g. However, the giant magnetostrictive element 112 may be spaced apart from the side surface of the protruding portion of the vibration conducting portion 111g without being in contact with the side surface, and the giant magnetostrictive element 112 may also be fixed to the side surface with an adhesive or the like.

The vibration transmitted from the fixing plate 111f to the vibrator head 111a via the vibration conducting portion 111g is transmitted to the anchor head 121 of the anchor 12. Then, the anchor leg 122 of the anchor 12 vibrates and transmits the vibration to the skull SK. The anchor leg 122 of the anchor 12 protrudes from the vibration generating device 11 and is embedded in the skull SK.

### <Attachment of Bone Conduction Hearing-Aid Unit>

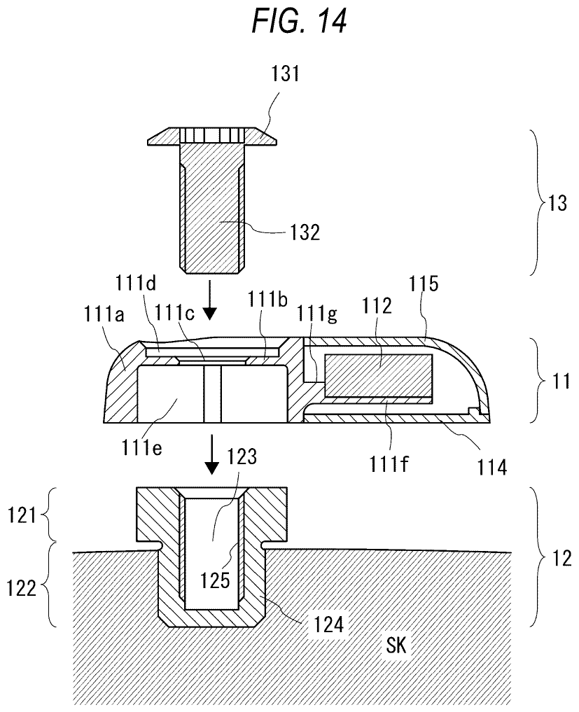

The bone conduction hearing-aid unit 1 is disposed by being embedded in the head of the patient through surgery. At the time of attachment, as illustrated in FIG. 14, the vibration generating device 11 and the male screw 13 are fixed to the anchor 12 fixed to the skull SK as indicated by an arrow. FIG. 14 is a cross-sectional view schematically illustrating a state before the vibration generating device 11 is attached to the skull SK.

When the bone conduction hearing-aid unit 1 is disposed in the patient, an incision is made behind an ear in the second direction illustrated in FIG. 1, and the scalp SC is incised. Next, the skull SK is incised to form a hole for the anchor 12. Further, the anchor leg 122 of the anchor 12 is screwed into the formed hole and fixed. A lower part of FIG. 14 illustrates the anchor 12 in which the anchor leg 122 is fixed to the skull SK. The anchor head 121 has a polygonal outer surface and is formed with an anchor recess 123 recessed from a side opposite the anchor leg 122. An outer side of the anchor leg 122 is the male screw portion 124, and the anchor leg 122 having the male screw portion 124 is screwed into the skull SK by turning the hexagonal columnar anchor head 121 with a wrench. An inner surface of the anchor recess 123 is the female screw portion 125. The anchor leg 122 is embedded in the skull SK, but the anchor head 121 is not embedded and protrudes above the skull SK.

Thereafter, the vibration generating device 11 is inserted between the scalp SC and the skull SK from the bottom side, and the anchor head 121 of the anchor 12 is covered with the lower surface recess 111e which is a polygonal recess. Then, the male screw 13, which is a fixing pin, is detachably fixed to the female screw portion 125 of the anchor recess 123 through the locking hole 111c, which is a hole penetrating into the lower surface recess 111e of the vibration generating device 11. In this way, the vibration generating device 11 is detachably fixed to the anchor 12.

FIG. 14 schematically illustrates a cross-sectional view of the vibration generating device 11 and the male screw 13 before being attached to the anchor 12. After the vibration generating device 11 is fixed to the anchor 12 by the male screw 13, the incised scalp SC is sutured. After the surgery, as illustrated in FIGS. 2 and 3, since no wiring or the like is led out from the scalp SC and the wound on the scalp SC is completely blocked, the risk of infectious diseases is low.

As illustrated in FIG. 10, in the bone conduction hearing-aid unit 1 of the first embodiment, the anchor 12 is positioned away from the giant magnetostrictive element 112 on a lateral side of the giant magnetostrictive element 112 extending in the longitudinal direction Ld. The vibration generated by bending the fixing plate 111f and the giant magnetostrictive element 112, as illustrated in FIG. 12, is transmitted from the fixing plate 111f to the anchor 12 via the vibration conducting portion 111g.

In the bone conduction hearing-aid unit 1 of the first embodiment, the giant magnetostrictive element 112, which expands and contracts greatly due to a magnetic field, is fixed to the fixing plate 111f, which hardly expands or contracts due to a magnetic field. By this fixation, as illustrated in FIG. 12, expansion and contraction vibration of the giant magnetostrictive element 112 generated by a magnetic field frequency is converted into bending vibration of the fixing plate 111f to amplify the vibration, and the vibration can be generated with high efficiency. Since the longitudinal direction Ld of the giant magnetostrictive element 112 is substantially parallel to the surface of the skull SK, the vibration generating device 11 can be made thin.

The permanent magnets 113 provided at both ends of the giant magnetostrictive element 112 not only generate a bias magnetic field, but also function as weights when the fixing plate 111f vibrates in a bent manner, thereby contributing to the generation of large vibration.

### Second Embodiment

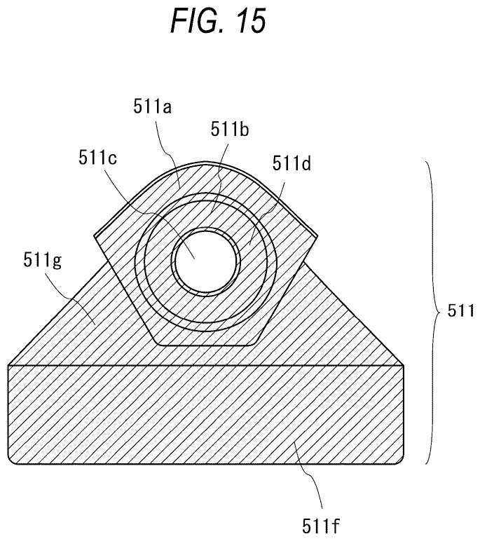

In the vibrator 111 of the first embodiment, as illustrated in FIGS. 6 and 8, the vibration conducting portion 111g has a convex shape in which a rectangular protrusion in the center forms a step. However, the fixing plate may have another shape. FIG. 15 illustrates a top view of a vibrator 511 in a bone conduction hearing-aid unit 5 (not illustrated) of a second embodiment.

A fixing plate 511f has a rectangular shape and is thin. A vibration conducting portion 511g connecting a vibrator head 511a and the fixing plate 511f is thinner than the vibrator head 511a and is thicker than the fixing plate 511f. A side of the vibration conducting portion 511g closer to the fixing plate 511f is formed to have the same length as the fixing plate 511f, and a side closer to the vibrator head 511a is formed to be shorter than the fixing plate 511f. Same or similarly to the first embodiment, the vibration conducting portion 511g and the fixing plate 511f have different thicknesses, and a step is formed between upper surfaces thereof. Same or similarly to the first embodiment, the vibrator head 511a protrudes upward and downward from the vibration conducting portion 511g. A giant magnetostrictive element and a permanent magnet are fixed to the fixing plate 511f of the vibrator 511 same or similarly to the first embodiment.

Unlike the first embodiment, no step is formed in the vibration conducting portion 511g of the vibrator 511 in the second embodiment. The vibration conducting portion 511g of the second embodiment has a shape in which a vertex of a substantially isosceles triangle with a lateral side of the fixing plate 511f as a bottom side is embedded in the vibrator head 511a. In the second embodiment as well, vibration caused by the bending of the fixing plate 511f is transmitted to the vibrator head 511a via the vibration conducting portion 511g. In the second embodiment, a magnetic field frequency is applied to a vibration generating device 51 by the extracorporeal unit 2 same or similar to that of the first embodiment illustrated in FIGS. 2 to 3 to generate vibration. In the bone conduction hearing-aid unit 5 of the second embodiment, configurations other than the vibration conducting portion 511g are the same or similar to those of the first embodiment.

The vibration conducting portion 511g of the second embodiment has a substantially isosceles triangle shape. A locking hole 511c is positioned in the vicinity of a position where two equal sides of the vibration conducting portion 511g intersect. The position of the locking hole 511c is the position of an anchor (not illustrated). The giant magnetostrictive element (not illustrated) is fixed to the fixing plate 511f along a bottom side of the vibration conducting portion 511g. In the bone conduction hearing-aid unit 5 of the second embodiment as well, an anchor axis, which is a central axis of the anchor, is provided at a position intersecting with a perpendicular bisector of a center line, in a longitudinal direction, of the giant magnetostrictive element. An angle θ formed by the two equal sides of the vibration conducting portion 511g corresponding to a vertex angle is preferably 600 or more and 100° or less.

### Third Embodiment

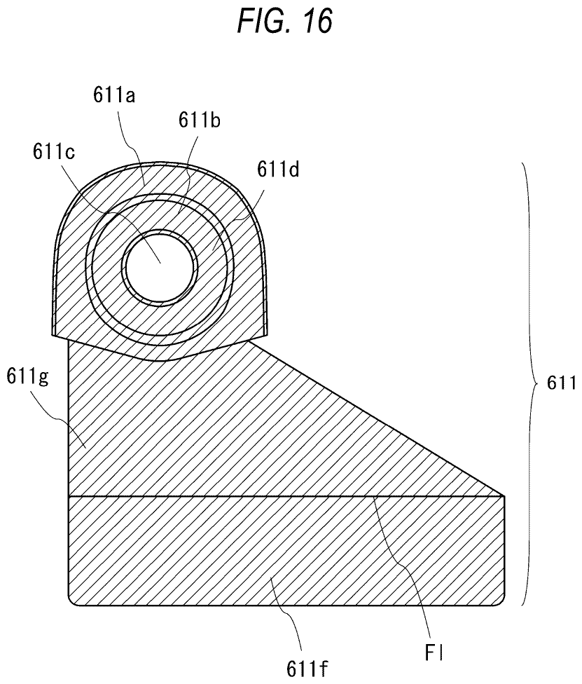

The fixing plate may have another shape. FIG. 16 illustrates a top view of a vibrator 611 in a bone conduction hearing-aid unit 6 (not illustrated) of a third embodiment. A fixing plate 611f has a rectangular shape when viewed from above and is thin. A vibration conducting portion 611g connecting a vibrator head 611a and the fixing plate 611f is thinner than the vibrator head 611a and is thicker than the fixing plate 611f. A side of the vibration conducting portion 611g closer to the fixing plate 611f is formed to have the same length as the fixing plate 611f, and a side closer to the vibrator head 611a is formed to be shorter than the fixing plate 611f Same or similarly to the first and second embodiments, the vibration conducting portion 611g and the fixing plate 611f have different thicknesses, and a step is formed between upper surfaces thereof. Same or similarly to the first and second embodiments, the vibrator head 611a protrudes upward and downward from the vibration conducting portion 611g. A giant magnetostrictive element and a permanent magnet are fixed to the fixing plate 611f of the vibrator 611 same or similarly to the first embodiment.

Same or similarly to the second embodiment, the vibration conducting portion 611g of the vibrator 611 of the third embodiment has a shape in which a vertex of a triangle shape with a lateral side of the fixing plate 611f as a bottom side is embedded in the vibrator head 611a. However, unlike the second embodiment, the vibrator head 611a is positioned on a lateral side of a position deviated from a center of a fixing plate long side F1, which is a long side of the upper surface of the fixing plate 611f The vibration conducting portion 611g of the third embodiment has a right triangle shape in which one of the vertices in contact with the fixing plate 611f is a right angle. In the third embodiment as well, the vibration caused by the bending of the fixing plate 611f is transmitted to the vibrator head 611a via the vibration conducting portion 611g.

In the third embodiment, since the vibrator head 611a is positioned on the lateral side of the position deviated from the center of the long side of the upper surface of the fixing plate 611f, a bottom case and a top case are shaped to match this. Other configurations are the same or similar to those of the first and second embodiments. In the third embodiment as well, a magnetic field frequency is applied to a vibration generating device 61 by the extracorporeal unit 2 same or similar to that of the first embodiment illustrated in FIGS. 2 to 3 to generate vibration.

### Fourth Embodiment

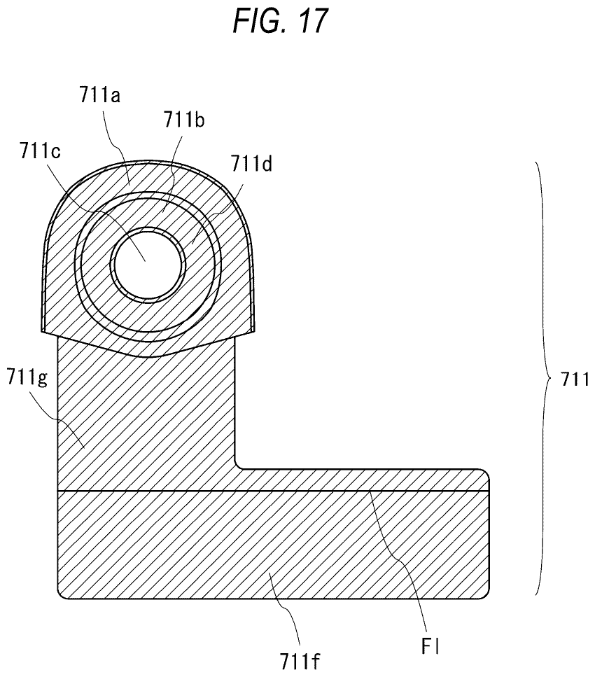

FIG. 17 illustrates a top view of a vibrator 711 of a bone conduction hearing-aid unit 7 (not illustrated) in a fourth embodiment, which has yet another shape. A fixing plate 711f has a rectangular shape when viewed from above and is thin. A vibration conducting portion 711g connecting a vibrator head 711a and the fixing plate 711f is thinner than the vibrator head 711a and is thicker than the fixing plate 711f. A side of the vibration conducting portion 711g closer to the fixing plate 711f is formed to have the same length as the fixing plate 711f. Same or similarly to the first to third embodiments, the vibration conducting portion 711g and the fixing plate 711f have different thicknesses, and a step is formed between upper surfaces thereof. Same or similarly to the first to third embodiments, the vibrator head 711a protrudes upward and downward from the vibration conducting portion 711g. A giant magnetostrictive element and a permanent magnet are fixed to the fixing plate 711f of the vibrator 711 same or similarly to the first to third embodiments. Same or similarly to the third embodiment, the vibrator head 711a of the fourth embodiment is positioned on a lateral side of a position deviated from a center of a fixing plate long side F1, which is a long side of the upper surface of the fixing plate 711f.

On the other hand, unlike the third embodiment, the vibration conducting portion 711g of the vibrator 711 in the fourth embodiment has a shape in which a notch is provided in an oblique side of the vibration conducting portion 611g of the third embodiment, and is substantially L-shaped when viewed from above. It can also be said that the vibration conducting portion 711g in the fourth embodiment has a shape in which the protrusion of the small rectangular parallelepiped shape between the vibration conducting portion 711g and the vibrator head 111a in the first embodiment is shifted to one side in the vibration conducting portion 111g. The vibration conducting portion 711g has a shape in which a long rectangular parallelepiped body along a lateral side of the fixing plate 711f is connected to a rectangular parallelepiped body protruding in a vertical direction from the lateral side in the vicinity of one end of the lateral side. In the fourth embodiment as well, the vibration caused by the bending of the fixing plate 711f is transmitted to the vibrator head 711a via the vibration conducting portion 711g.

In the fourth embodiment, since the vibrator head 711a is positioned at the position deviated from the center of the fixing plate long side F1 of the fixing plate 711f, a bottom case and a top case are shaped to match this. Other configurations are the same or similar to those of the first and second embodiments. The bottom case and the top case may have the same or similar shape as in the third embodiment, but may also have a shape with a notch that reflects a notch in the fixing plate 711f. In the fourth embodiment as well, a magnetic field frequency is applied to a vibration generating device 71 by the extracorporeal unit 2 same or similar to that of the first embodiment illustrated in FIGS. 2 to 4 to generate vibration.

### Fifth Embodiment

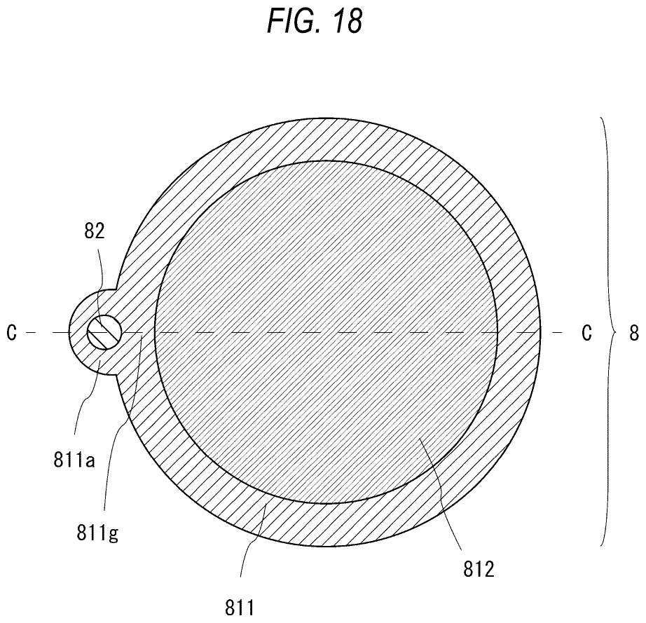

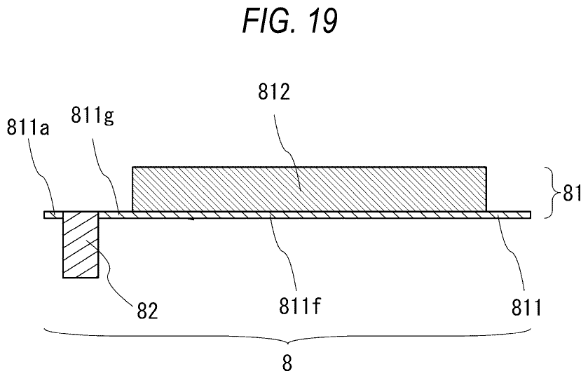

The shapes of the fixing plates 111f, 511f, 611f, and 711f in the first to fourth embodiments are rectangular. The shapes of the vibration conducting portions 111g, 511g, 611g, and 711g are a convex shape, an isosceles triangle shape, a right triangle shape, and an L shape, respectively. The shapes of the cases and the vibration generating devices also reflect these shapes. However, other shapes may be adopted. FIGS. 18 and 19 illustrate a vibrator 811 and the like in a circular plate-shaped bone conduction hearing-aid unit 8 (not illustrated) of a fifth embodiment. FIG. 18 is a top view, and FIG. 19 is a cross-sectional view taken along line C-C in FIG. 18. In FIGS. 18 and 19, a case for accommodating the vibrator 811 and the like is not illustrated.

In the bone conduction hearing-aid unit 8 of the fifth embodiment, a circular plate-shaped giant magnetostrictive element 812 is fixed to a fixing plate 811f of the circular plate-shaped vibrator 811. Same or similarly to the description of the first embodiment with reference to FIG. 12, the fixing plate 811f is bent and vibrates due to the expansion and contraction of the giant magnetostrictive element 812 caused by a magnetic field frequency. The vibration is transmitted to a vibrator head 811a via the vibration conducting portion 811g, and an anchor 82 fixed to the skull SK vibrates. Further, the vibration is transmitted from the anchor 82 to the skull SK and then to an inner ear through bone conduction.

### <Another Extracorporeal Unit>

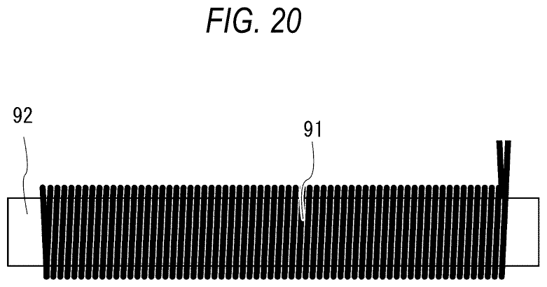

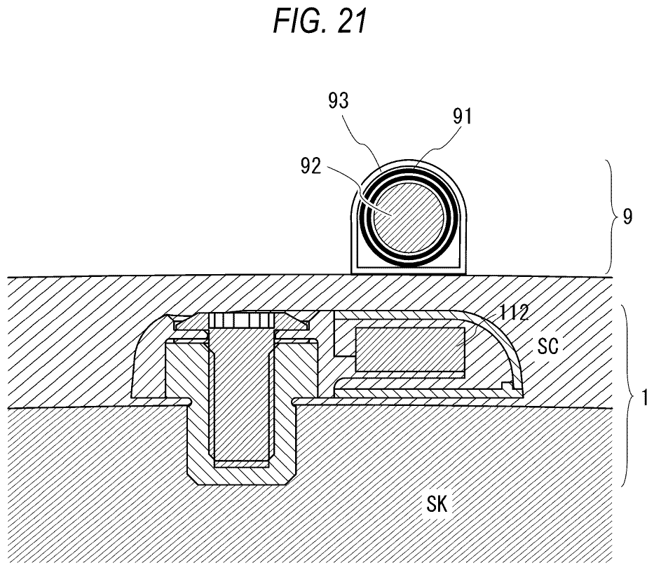

In the first to fifth embodiments, a magnetic field frequency is applied to the extracorporeal unit 2 illustrated in FIGS. 2 to 4. However, the magnetic field frequency may be applied to another extracorporeal unit. FIG. 20 is a top view of an electromagnet in an extracorporeal unit 9. FIG. 21 illustrates a cross-sectional view when the extracorporeal unit 9 is attached to an outer surface of a head to which the bone conduction hearing-aid unit 1 of the first embodiment is disposed. The extracorporeal unit 9, the scalp SC, and the skull SK are illustrated in cross section. In the extracorporeal unit 9, the electromagnet in which a coil 91 is wound around a long cylindrical magnetic body 92 is accommodated in a case 93. In the extracorporeal unit 9 of FIG. 20, the case 93 is omitted. The electromagnet has a rod shape in which a length in an axial direction is larger than a diameter.

As illustrated in FIG. 21, the extracorporeal unit 9 is disposed outside the scalp SC in the vicinity of the giant magnetostrictive element 112 such that a central axis of the electromagnet including the coil 91 and the magnetic body 92 is parallel to and above the center line C1 (see FIG. 10) of the giant magnetostrictive element 112 in the bone conduction hearing-aid unit 1. The electromagnet is disposed at a position substantially overlapping the giant magnetostrictive element 112 when viewed from above. In the extracorporeal unit 9, a magnetic field frequency is formed in the vicinity of the electromagnet in which the coil 91 is wound around the long cylindrical magnetic body 92. Then, the giant magnetostrictive element 112 expands and contracts due to the magnetic field frequency formed on a lateral side (lower side in FIG. 21) of the electromagnet including the coil 91 and the magnetic body 92, and generates vibration. The same applies to the bone conduction hearing-aid units 5 to 8 of the second to fifth embodiments.

### Modification

The vibration generators in the first to fourth embodiments apply a bias magnetic field by a permanent magnet, but bending due to the magnetic field occurs even without the bias magnetic field. Therefore, it is possible to adopt a configuration in which the permanent magnet is not provided in the vibration generators of the first to fourth embodiments. In the bone conduction hearing-aid unit of the first embodiment, an outer surface of the anchor head 121 of the anchor 12 is hexagonal, and the lower surface recess 111e is a polygonal recess whose inside is substantially hexagonal as illustrated in FIGS. 7 and 8. The same applies to the other embodiments. However, the outer surface of the anchor head and the lower surface recess may also be of other polygonal shapes, such as pentagons. Alternatively, a shape may be adopted in which a deformed portion for preventing rotation is provided in a part of a circular portion.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A bone conduction hearing-aid unit embedded under a scalp, the bone conduction hearing-aid unit comprising:
a vibration generator configured to generate vibration; and
an anchor,
wherein a magnetic field frequency is applied to the vibration generator from the outside of the scalp to generate vibration, and
the vibration is transmitted to a skull via the anchor.

2. The bone conduction hearing-aid unit according to claim 1,
wherein the vibration generator includes a giant magnetostrictive element.

3. The bone conduction hearing-aid unit according to claim 2,
wherein the vibration generator includes a fixing plate configured to fix the giant magnetostrictive element,
the giant magnetostrictive element expands and contracts by receiving the magnetic field frequency, and
the fixing plate and the giant magnetostrictive element is bent by the expansion and contraction of the giant magnetostrictive element, to generate the vibration.

4. The bone conduction hearing-aid unit according to claim 3,
wherein the giant magnetostrictive element has a surface along a longitudinal direction fixed to the fixing plate,
the giant magnetostrictive element expands and contracts in the longitudinal direction by receiving the magnetic field frequency, and
the fixing plate and the giant magnetostrictive element is bent by the expansion and contraction of the giant magnetostrictive element, to generate the vibration.

5. The bone conduction hearing-aid unit according to claim 4,
wherein an anchor axis is positioned away from the giant magnetostrictive element in a direction perpendicular to the longitudinal direction of the giant magnetostrictive element, the anchor axis being a central axis of the anchor, and
the fixing plate is configured to transmit the vibration to the anchor via a vibration conducting portion, the vibration being generated by bending the fixing plate and the giant magnetostrictive element.

6. The bone conduction hearing-aid unit according to claim 5,
wherein the anchor axis is provided at a position intersecting with a perpendicular bisector of a center line, in the longitudinal direction, of the giant magnetostrictive element.

7. The bone conduction hearing-aid unit according to claim 6,
wherein the vibration conducting portion has a substantially isosceles triangle shape,
the anchor is positioned in the vicinity of a position where two equal sides of the vibration conducting portion intersect, and
the giant magnetostrictive element is fixed along a bottom side of the vibration conducting portion.

8. The bone conduction hearing-aid unit according to claim 7,
wherein an angle formed by the two equal sides of the vibration conducting portion is 600 or more and 100° or less.

9. The bone conduction hearing-aid unit according to claim 2,
wherein the giant magnetostrictive element is sandwiched between two permanent magnets.

10. The bone conduction hearing-aid unit according to claim 3,
wherein the vibration generator includes no permanent magnet.
